(19) United States
(12) Patent Application Publication
(10) Pub. No.: US 2010/0025979 A1
(43) Pub. Date: Feb. 4, 2010

(54) Protective Element (Variants), Method For The Production Thereof, Counterfeit-Proof Material And Value Paper

(76) Inventors: Arkady Vladimirovich Trachuk, St. Petersburg (RU); Andrei Valerievich Cheglakov, Moscow (RU); Andrei Borisovich Kuryatnikov, Pushkino (RU)

Correspondence Address: FITCH EVEN TABIN & FLANNERY, 120 SOUTH LASALLE STREET, SUITE 1600, CHICAGO, IL, 60603-3406, US

(21) Appl. No.: 12/520,710

(22) PCT Filed: Dec. 21, 2007
(86) PCT No.: PCT/RU07/00722

§ 371 Date: Jun. 22, 2009

(30) Foreign Application Priority Data
Dec. 21, 2006 (RU) 2006145422

(51) Int. Cl. B42D 15/10; B05D 5/00; B05D 1/36

(52) U.S. Cl. 283/85; 427/261

(57) ABSTRACT

The invention relates to security element for different articles including banknotes, valuable papers, credit cards, documents, certificates and other similar articles, to a method for producing thereof and also to a counterfeit-proof material and valuable document provided with the security element. The security element has several layers each having definite optical properties which are different for each layer, such as color, reflectance, transparency, density. At the same time, at least one external layer is formed with protrusions arranged in a determined and/or random order. A lower layer is formed to be continuous while all layers together form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection. The disclosed invention makes it possible to develop a simple and available security element exhibiting optimized protective properties.

### FIELD OF THE INVENTION

The invention relates to a security element for different articles, including banknotes, valuable papers, credit cards, documents, certificates and other similar articles, to a method for the production thereof and also to a counterfeit-proof material and valuable document provided with a security element.

### BACKGROUND OF THE INVENTION

Said articles may be preforms or semi-finished products designed to be used further in the production of banknotes, valuable papers, credit cards, documents, cheques, cheque cards, passports, tickets, certificates, passes, and the like.

To check the authenticity, articles are usually provided with complicated security elements that allow their visual and/or automatic inspection. The prior art security elements are complicated while methods for the production thereof are laborious and complex which results in increased costs of articles and materials provided with such elements.

Sometimes, different security features are combined in one security element, wherein some features may be detected only in an automated fashion while others may be detected by the naked eye. But it is not always possible because of that or other reasons and is associated with technical complexities. Due to said reason, it is often necessary to achieve the optimal effect from use of only one security feature.

A multilayered security element for counterfeit-proof documents is known from publication (WO 03/068,525 published on Aug. 21, 2003), said element using several layers—with an interference element, with a diffraction structure, and with a flip-flop color change effect accomplished due to presence of the interference element (RU2004125286A published on Jun. 10, 2005 which corresponds to EP 03/00447 of 17.01.2003).

The basic problem associated with use of a layer having magnetic properties is that the magnetic materials usually have a low reflectance. In turn, materials with an acceptable reflectance have less marked magnetic properties. The disadvantages of said element are the insufficient level of protection, the production complexity and the high cost.

Said reference also discloses a method for the producing a security element, comprising sequential application of magnetic and other layers assuming presence of the complicated expensive equipment and the complexity of compliance with predetermined process parameters.

### DISCLOSURE OF THE INVENTION

Said disadvantages are eliminated by the present invention that is directed to an object of providing a security element exhibiting optimized properties, a counterfeit-proof material, and a method for producing said security element. At the same time, the present invention makes it possible to provide a simpler, available and less expensive security element.

In accordance with the present invention, said object is accomplished by one embodiment according to which a for articles such as banknotes, valuable papers, credit cards, documents, certificates, and other similar articles, having several layers is characterized in that the layers have definite properties which are different for each layer, such as color, reflectance, transparency, density, wherein at least one external layer is formed with protrusions arranged in a determined and/or random order, a lower layer is formed to be continuous while all layers together form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection.

In accordance with another embodiment, a security element for articles such as banknotes, valuable papers, credit cards, documents, certificates, and other similar articles, having several layers is characterized in that the layers have definite properties which are different for each layer, such as color, reflectance, transparency, density, wherein at least one external layer is formed with protrusions arranged in a determined and/or random order and comprises a blue pigment, a lower layer is formed to be continuous and comprises a yellow pigment while all layers together form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection.

Also three embodiments of the security element use layers with such pigments as follows:
red and blue;
red and yellow;
blue and violet.

Such embodiments expand the kitting of means with said purpose, each being a security element with an improved degree of security.

Further, the security element is additionally characterized in that optical properties of layers make it possible to visually and/or automatically inspect the authenticity of articles such as banknotes, valuable papers, credit cards, documents, certificates, and other similar articles.

Furthermore, the security element is further characterized in that the external layer is formed with protrusions arranged at a predetermined pitch from each other.

Said object is also accomplished by a novel method for the producing a security element, layers form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection.

The claimed method is further characterized by creating a type of the multilayered structure configuration by a metallography plate used therein.

The claimed method is further characterized by applying the continuous layer by offset and/or stencil printing and/or introducing a film and/or covering with a lacquer and/or a metallized foil and/or other printing technique.

The claimed method is further characterized by applying the continuous layer by introducing a film with a diffraction lattice and/or color-variable metallized foil.

The object of the present invention is also accomplished by a novel counterfeit-proof material such as paper, plastic, textile and other material for the production of banknotes, valuable papers, credit cards, documents, certificates, and other similar articles, said material comprising a security element with all its features mentioned above, and is accomplished also by a counterfeit-proof valuable document such as a banknote, a valuable paper, a credit card, a certificate, and other similar document provided with a security element with all its features mentioned above, said document allowing at least visual inspection thereof.

The claimed combination said substantial features provides the technical result which consists in improving the degree of security against counterfeit for articles, materials, valuable documents and in developing a simpler method for the production of such a security elements, and in reducing the material costs for such the production as well.

### BRIEF DESCRIPTION OF DRAWING FIGURES

The invention is explained by drawings.

FIG. 1 illustrates a multilayered structure of security element layers where 1 is a substrate-material, 2 is a protective layer, and 3 is an external layer with protrusions forming a predetermined structure configuration.

FIG. 2 illustrates a “checkerboard” structure where an upper layer with protrusions comprises a pigment—blue (colors are not shown in the Figure) while a continuous layer comprises a pigment of a different color, that is, yellow one.

FIG. 3 shows different profiles of a metallography plate.

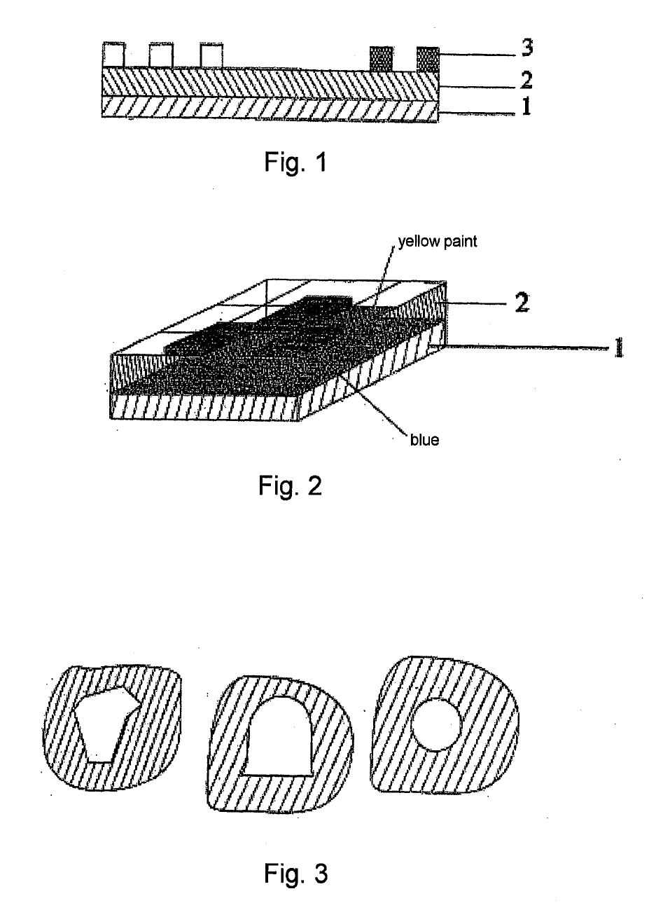

### THE BEST EMBODIMENT OF THE INVENTION

The claimed invention is supported by particular embodiments thereof.

### Example 1

To produce a security element, a continuous layer is applied onto a film—which serves as a substrate—by incorporating a film with a yellow pigment, and then one layer with a blue pigment is applied thereto, said layer being formed with protrusions arranged at a predetermined pitch, as shown in FIG. 2. The applied layers form a multilayered structure with a three-dimensional “checkerboard” configuration, wherein the structure develops at least one effect amenable to visual inspection: superposition of the blue and yellow pigments gives a color perceived as green by a person. At the same time, when the element is viewed from above, a picture is seen which was obtained due to different characteristics of the continuous layer and the external layer with protrusions (of the three-dimensional structure). When the security element is viewed at an angle, only a characteristic of the external layer (the “checkerboard” structure in the present case) is perceived. Such the security element provides an effect amenable to visual (computer-readable) inspection and simultaneously permits automatic inspection thereof (depending upon selection of optical characteristics).

### Example 2

To produce a counterfeit-proof material, a continuous layer is applied onto a paper—which serves as a substrate—by offset printing with a yellow pigment, and then a layer having a blue pigment and formed with protrusions arranged at a predetermined pitch is applied similarly to that in Example 1. A linear configuration with longitudinal strips is provided using this plate. The resulted material with such a security element may be used in future as a semi-finished product for the producing articles with a high level of protection against counterfeit.

### Example 3

To produce a counterfeit-proof material, a continuous layer being a transparent film is applied onto a paper—which serves as a substrate, and then an external opaque layer having a pigment and formed with protrusions arranged as a linear structure is applied. A linear configuration with longitudinal strips is provided using this plate. The resulted material with such a security element may be used in future as a semi-finished product for production of articles with a high level of protection against counterfeit.

### Example 4

An identity card with a security element is produced. A paper layer is applied on substrate layer—an insert with information. The paper layer is coated by a polymer layer being a laminate. A continuous layer with a yellow pigment is applied onto the laminate serving as a substrate, and then—similarly to Example 2—a layer having a blue pigment and formed with protrusions arranged at a predetermined pitch is applied thereto. The resulted effect is amenable to visual inspection and provides a high level of protection against counterfeit for a document.

It should be noted that a document may be both multilayered and composed of a single layer, and application of such a security element is possible not only onto polymeric layers but also onto other materials such as paper, paperboard, metal, etc.

### INDUSTRIAL APPLICABILITY

Thus, use of the claimed invention makes it possible to solve a problem of developing a security element exhibiting optimized security properties, a counterfeit-proof material, a counterfeit-proof valuable document, and a method for the production of such a security element. At the same time, the present invention makes it possible to develop a simpler, available and less expensive security element.

1. A security element for articles such as banknotes, valuable papers, credit cards, documents, certificates, and other similar articles, having several layers, said security element comprising layers having definite optical properties which are different for each layer, such as color, reflectance, transparency, density, wherein at least one external layer is formed with protrusions arranged in a determined and/or random order, a lower layer is formed to be continuous while all layers together form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection.

2. The element according to claim 1, wherein optical properties of layers make it possible to visually and/or automatically inspect authenticity of articles such as banknotes, valuable papers, credit cards, documents, certificates, and other similar articles.

3. The element according to claim 1, wherein the external layer is formed with protrusions arranged at a predetermined pitch from each other.

4. A security element for articles such as banknotes, valuable papers, credit cards, documents, certificates, and other similar articles, having several layers, said security element comprising layers having definite optical properties which are different for each layer, such as color, reflectance, transparency, density, wherein at least one external layer is formed with protrusions arranged in a determined and/or random order and comprises a blue pigment, a lower layer is formed to be continuous and comprises a yellow pigment while all layers together form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection.

5. The element according to claim 4, wherein optical properties of layers make it possible to visually and/or automatically inspect authenticity of articles such as banknotes, valuable papers, credit cards, documents, certificates, and other similar articles.

6. The element according to claim 4, wherein the external layer is formed with protrusions arranged at a predetermined pitch from each other.

7. A security element for articles such as banknotes, valuable papers, credit cards, documents, certificates, and other similar articles, having several layers, said protective element comprising layers having definite optical properties which are different for each layer, such as color, reflectance, transparency, density, wherein at least one external layer is formed with protrusions arranged in a determined and/or random order and comprises a red pigment, a lower layer is formed to be continuous and comprises a blue pigment while all layers together form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection.

8. A security element for articles such as banknotes, valuable papers, credit cards, documents, certificates, and other similar articles, having several layers, said security element comprising layers having definite optical properties which are different for each layer, such as color, reflectance, transparency, density, wherein at least one external layer is formed with protrusions arranged in a determined and/or random order and comprises a red pigment, a lower layer is formed to be continuous and comprises a yellow pigment while all layers together form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection.

9. A security element for articles such as banknotes, valuable papers, credit cards, documents, certificates, and other similar articles, having several layers, said security element comprising layers having definite optical properties which are different for each layer, such as color, reflectance, transparency, density, wherein at least one external layer is formed with protrusions arranged in a determined and/or random order and comprises a blue pigment, a lower layer is formed to be continuous and comprises a violet pigment while all layers together form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection.

10. A method for producing a security element according to claim 1, 2 or 3 comprising applying a continuous layer onto a substrate made of a material such as paper, plastic, textile and other materials for the production of banknotes, valuable papers, credit cards, documents, certificates, and other similar articles; and applying at least one layer having protrusions arranged in a determined and/or random order onto the continuous layer such that the layers form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection.

11. The method according to claim 10, wherein a type of the multilayered structure configuration is defined by a metallography plate used therein.

12. The method according to claim 10, wherein the continuous layer is applied by offset and/or stencil printing and/or introducing a film and/or coating with a lacquer and/or a metallized foil and/or other printing technique.

13. The method according to claim 12, wherein the continuous layer is applied by introducing a film with a diffraction lattice and/or color-variable metallized foil.

14. A method for producing a security element according to claim 4, 5 or 6 comprising applying a continuous layer onto a substrate made of a material such as paper, plastic, textile and other materials for the production of banknotes, valuable papers, credit cards, documents, certificates, and other similar articles; and applying at least one layer having protrusions arranged in a determined and/or random order onto the continuous layer such that the layers form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection.

15. The method according to claim 14, wherein a type of the multilayered structure configuration is defined by a metallography plate used therein.

16. The method according to claim 14, wherein the continuous layer is applied by offset and/or stencil printing and/or introducing a film and/or coating with a lacquer and/or a metallized foil and/or other printing technique.

17. The method according to claim 16, wherein the continuous layer is applied by introducing a film with a diffraction lattice and/or color-variable metallized foil.

18. A method for producing a security element according to claim 7, wherein a continuous layer is applied onto a substrate made of a material such as paper, plastic, textile and other materials for the production of banknotes, valuable papers, credit cards, documents, certificates, and other similar articles; and applying at least one layer having protrusions arranged in a determined and/or random order onto the continuous layer such that the layers form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection.

19. The method according to claim 18, wherein a type of the multilayered structure configuration is defined by a metallography plate used therein.

20. The method according to claim 18, wherein the continuous layer is applied by offset and/or stencil printing and/or introducing a film and/or coating with a lacquer and/or a metallized foil and/or other printing technique.

21. The method according to claim 20, wherein the continuous layer by introducing a film with a diffraction lattice and/or color-variable metallized foil.

22. A method for producing a security element according to claim 8, comprising applying a continuous layer onto a substrate made of a material such as paper, plastic, textile and other materials for the production of banknotes, valuable papers, credit cards, documents, certificates, and other similar articles; and applying at least one layer having protrusions arranged in a determined and/or random order onto the continuous layer such that the layers form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection.

23. The method according to claim 22, wherein a type of the multilayered structure configuration is defined by a metallography plate used therein.

24. The method according to claim 22, wherein the continuous layer is applied by offset and/or stencil printing and/or introducing a film and/or coating with a lacquer and/or a metallized foil and/or other printing technique.

25. The method according to claim 24, wherein the continuous layer is applied by introducing a film with a diffraction lattice and/or color-variable metallized foil.

26. A method for producing a security element according to claim 9, comprising applying a continuous layer onto a substrate made of a material such as paper, plastic, textile and other materials for the production of banknotes, valuable papers, credit cards, documents, certificates, and other similar articles; and applying at least one layer having protrusions arranged in a determined and/or random order onto the continuous layer such that the layers form a multilayered structure with a three-dimensional net and/or checkerboard and/or cell and/or mesh and/or linear configuration in the form of patterns, symbols, drawings, characters or codes, wherein the structure develops at least one effect amenable to visual and/or automatic inspection.

27. The method according to claim 26, wherein a type of the multilayered structure configuration is defined by a metallography plate used therein.

28. The method according to claim 26, wherein the continuous layer is applied by offset and/or stencil printing and/or introducing a film and/or coating with a lacquer and/or a metallized foil and/or other printing technique.

29. The method according to claim 28, wherein the continuous layer is applied by introducing a film with a diffraction lattice and/or color-variable metallized foil.

30. A counterfeit-proof material such as paper, plastic, textile and other material for the production of banknotes, valuable papers, credit cards, documents, certificates, and other similar articles, said material comprising a security element according to claim 1, 2 or 3.

31. A counterfeit-proof material such as paper, plastic, textile and other material for the production of banknotes, valuable papers, credit cards, documents, certificates, and other similar articles, said material comprising a security element according to claim 4, 5 or 6.

32. A counterfeit-proof material such as paper, plastic, textile and other material for the production of banknotes, valuable papers, credit cards, documents, certificates, and other similar articles, said material comprising a security element according to claim 7.

33. A counterfeit-proof material such as paper, plastic, textile and other material for the production of banknotes, valuable papers, credit cards, documents, certificates, and other similar articles, said material comprising a security element according to claim 8.

34. A counterfeit-proof material such as paper, plastic, textile and other material for the production of banknotes, valuable papers, credit cards, documents, certificates, and other similar articles, said material comprising a security element according to claim 9.

35. A counterfeit-proof valuable document such as a banknote, a valuable paper, a credit card, a certificate, and other similar document provided with a security element according to claim 1, 2 or 3, said document allowing at least visual inspection thereof.

36. A counterfeit-proof valuable document such as a banknote, a valuable paper, a credit card, a certificate, and other similar document provided with a security element according to claim 4, 5 or 6 said document allowing at least visual inspection thereof.

37. A counterfeit-proof valuable document such as a banknote, a valuable paper, a credit card, a certificate, and other similar document provided with a security element according to claim 7, said document allowing at least visual inspection thereof.

38. A counterfeit-proof valuable document such as a banknote, a valuable paper, a credit card, a certificate, and other similar document provided with a security element according to claim 8, said document allowing at least visual inspection thereof.

39. A counterfeit-proof valuable document such as a banknote, a valuable paper, a credit card, a certificate, and other similar document provided with a security element according to claim 9, said document allowing at least visual inspection thereof.
